(19) United States
(12) Patent Application Publication
(10) Pub. No.: US 2003/0122275 A1
(43) Pub. Date: Jul. 3, 2003

(54) Method of creating a line made of plastic with a branch and mold for producing a line having a branch

(76) Inventor: Lars Koschnig, Dortmund (DE)

Correspondence Address: Kevin R. Spivak, Morrison & Foerster LLP, Suite 300, 1650 Tysons Boulevard, McLean, VA, 22102, US

(21) Appl. No.: 10/305,356

(22) Filed: Nov. 27, 2002

(30) Foreign Application Priority Data
Nov. 30, 2001 (DE) 10158663.9

(51) Int. Cl. B29C 45/26

(52) U.S. Cl. 264/138; 425/130; 425/289; 264/573

(57) ABSTRACT

A method of creating a line made of plastic with a branch. During blowing through of a flow cross section of the line, an annular web is created in the region of a flow cross section of the branch as a predetermined breaking location. Subsequently, a plastic part held by the web can be detached from the line.

### CLAIM FOR PRIORITY

This application claims priority to Application No. 10158663.9 which was filed in the German language on Nov. 30, 2001.

### TECHNICAL FIELD OF THE INVENTION

The invention relates to a method of creating a line made of plastic with a branch and to a mold for carrying out the method.

### BACKGROUND OF THE INVENTION

Lines are produced in fuel tanks of modern motor vehicles, for example as a venting line or fuel line. In conventional methods for producing the line with the branch, the flow cross section of the branch is cut out or punched out from the mold part after the line has been produced. The plastic forming the flow cross section of the branch is forced out, for example by means of an ejector, after the cutting out.

A disadvantage of the known method is that, during the cutting out or punching out, a burr protruding into the flow cross section of the line occurs and is difficult to remove. Furthermore, the known method is very time-consuming, since lines without a flow cross section of the branch first have to be produced. The mold for carrying out the known method requires a cutting or punching tool, which is susceptible to wear, and an ejector and is therefore of a particularly complex construction.

### SUMMARY OF THE INVENTION

The invention relates to a method of creating a line made of plastic with a branch, the line and the branch respectively having interconnected flow cross sections and a common wall, in which method a mold corresponding to the line with the branch is firstly filled with liquid plastic and the flow cross section of the line is blown out. Furthermore, the invention relates to a mold for carrying out the method with a mold part corresponding to the outer wall of the line and of the branch, with means for creating an internal pressure for the blowing out of a flow cross section of the line.

The invention discloses a method to produce a line with a branch particularly quickly and that the flow cross sections have a predetermined shape and size without any finishing. Furthermore, it is intended to provide a mold for carrying out the method at the lowest possible cost, with which parts falling out of the mold are avoided.

In one embodiment of the invention, the flow cross section of the branch is pre-formed apart from an annular web adjacent to the flow cross section of the line and by the web subsequently being severed.

In this embodiment, a predetermined breaking location for the flow cross section of the branch is created with the annular web. Subsequently, the plastic can be removed from the flow cross section of the branch in a simple manner. The removal of the plastic in this case requires little expenditure of force. Therefore, deformation of the line or the branch can be kept particularly low. The flow cross sections of the line and of the branch therefore have great accuracy in their shape and size. The annular pre-forming of the flow cross section of the branch has the effect that the plastic to be removed has intrinsic stability, thereby ensuring its removal largely without any burr. Since a separate operation is not required to bring about the annular reduction in the thickness of the wall, the method according to the invention requires particularly little expenditure of time.

According to one advantageous embodiment of the invention, the flow cross section of the branch can be created with particularly little expenditure of time if the plastic located in the flow cross section of the branch is pulled out and the web is thereby severed.

According to another advantageous embodiment of the invention, it helps to reduce further the expenditure of time for creating the flow cross section of the branch if, after the blowing out of the line, the flow cross section of the line is closed and the internal pressure in the line is increased until the plastic located in the flow cross section of the branch is forced out and the web is thereby severed.

According to another advantageous embodiment of the invention, it helps to increase further the accuracy of the shape and size of the flow cross sections if the removal of the plastic from the flow cross section of the branch takes place after it has at least partly solidified.

In the embodiment of a mold for carrying out the method at the lowest possible cost, there is a ring element arranged in the region of the flow cross section of the branch to reduce the wall thickness during the blowing out of the flow cross section of the line.

This embodiment allows the ring element to be used during the filling of the mold part with liquid plastic to create a free space which is not filled with plastic. As a result, the finished plastic part is provided with a predetermined breaking location. By breaking out the plastic located in the center of the ring element, the flow cross section in the branch is subsequently created. Since the ring element is provided for keeping free a region in the plastic, it is not subjected to any wear. The method of producing the line made of plastic with the branch can therefore be carried out at particularly low cost.

According to an advantageous embodiment of the invention, the position of the ring element in the mold part can be fixed in a simple manner if the ring element is arranged on a slide protruding into the mold part and guided in a longitudinally movable manner. This helps to bring about particularly low production costs, in particular when the line is made in large numbers.

According to another advantageous embodiment of the invention, the plastic part bounded by the ring element can be broken out in a particularly simple manner if the ring element has a peripheral cutting edge.

According to another advantageous embodiment of the invention, a perforation in the region of the predetermined breaking location can be created in a simple manner if the ring element has points arranged in a circular form. This allows the limits of stability of the predetermined breaking location to be set in a simple manner, so that spontaneous falling out of the plastic part bounded by the ring element is avoided even in the case of particularly soft plastics.

According to another advantageous embodiment of the invention, the plastic part bounded by the ring element can be pulled out in a simple manner after the plastic has solidified, and thereby detached from the plastic part of the line with the branch, if the ring element has in its center a cup-shaped or hemispherical depression or an undercut. Given a suitable choice of the plastic and the temperature, the depression has the effect that the plastic part to be removed is held on the slide by forces of adhesion.

According to another advantageous embodiment of the invention, the intended temperature of the plastic adjacent to the slide can be fixed in a simple manner if a cooling element or a heating element is arranged in the slide.

### BRIEF DESCRIPTION OF THE DRAWINGS

The invention allows numerous embodiments which are illustrated below and represented in the drawings, in which:

FIGS. 1a-1c show a method according to the invention with a mold for carrying out the method.

FIGS. 2a, 2b show another embodiment of the method according to the invention.

### DETAILED DESCRIPTION OF THE PREFERRED EMBODIMENTS

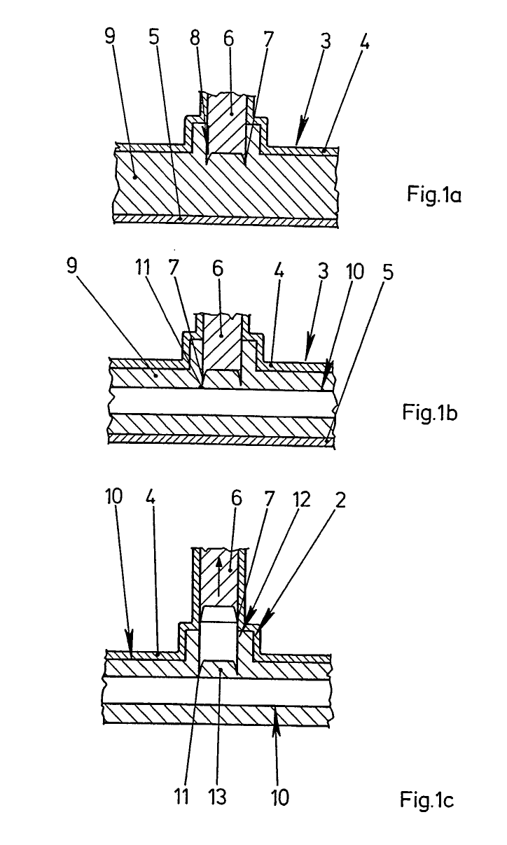

FIG. 1a shows a mold with a mold part 3 creating the outer wall of a line 1 to be produced, which is represented in FIG. 1c, and a branch 2. The mold part 3 is made up of mold halves 4, 5 and has, in the region of the branch 2 to be produced, a slide 6 with a ring element 7 arranged on its end face. The ring element 7 may have for the respective plastic a peripheral cutting edge or points arranged in a circular form. The slide 6 is of a planar configuration in the center of the ring element 7. The ring element 7 therefore bounds a cup-shaped depression 8. The mold part 3 is filled with liquid plastic 9, a heated thermoplastic. The slide 6 is at this time fixed in an intended position. During a subsequent cooling of the mold, the plastic 9 located in the mold part 3 solidifies from the outside.

After the build-up of an intended solidified layer of plastic 9, the mold part 3 is subjected to a pressure on one side and consequently still liquid plastic 9 in the center of the line 1 to be created is blown out. This method is represented in FIG. 1b. As a result, a flow cross section 10 of the line 1 is created. The ring element 7 is thereby covered with an annular web 11 of solidified plastic.

After the blowing out of the flow cross section of the line 1, the slide 6 is pulled out from the mold part 3. This step is represented in FIG. 1c. The slide 6 in this case leaves behind a flow cross section 12 in the branch 2. The connection of the flow cross section 12 of the branch 2 to the flow cross section 10 of the line 1 is blocked by a plastic part 13. Since this connection was pre-formed by the ring element 7, the plastic part 13 is connected to the line 1 via the annular web 11 and can be broken out in a simple manner. By an appropriate configuration of the surface of the slide 6 and suitable choice of the temperature of the plastic, the plastic part 13 can be securely held on the slide 6 by forces of adhesion or undercuts and can be detached when said slide is pulled out from the line 1.

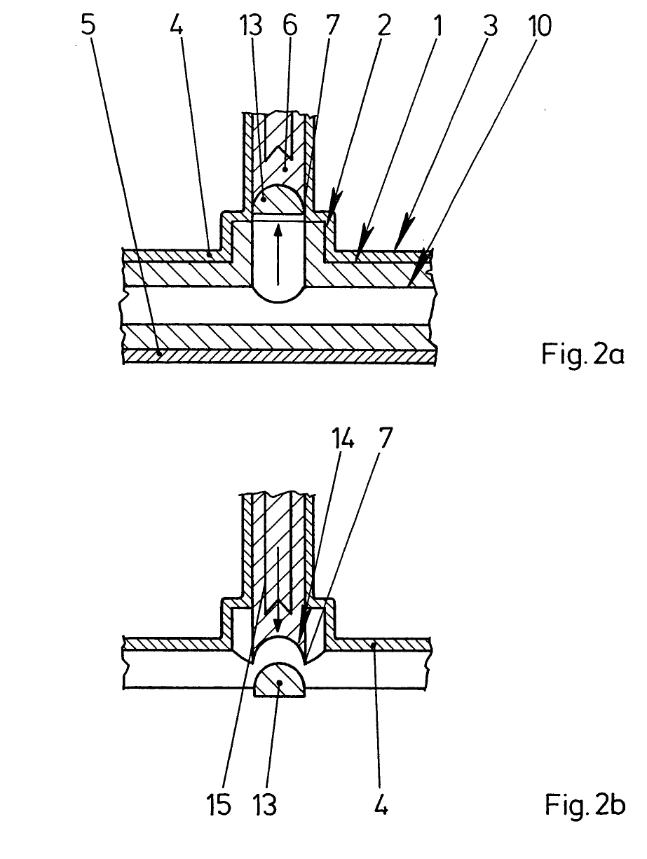

FIGS. 2a and 2b show another method of producing the line 1 with the branch 2. The mold part 3 of the mold, as represented in FIG. 1a, is initially filled with liquid plastic. FIG. 2a shows the method when blowing through the flow cross section 10 of the line 1. It can be seen here that the slide 6 is forced out of the mold part 3 by the pressure in the flow cross section 10 of the line 1. Alternatively, the slide 6 may be actively pulled. Consequently, the creation of the flow cross sections 10, 12 of the branch 2 and of the line 1 and the severing of the web, not represented in this FIG., formed by the ring element 7, take place in a single operation. The line 1 and the branch 2 can subsequently be removed from the mold part. The plastic part 13 bounded by the ring element 7 is subsequently detached from the slide 6. FIGS. 2a and 2b show that the ring element 7 bounds a hemispherical depression 14 arranged in the slide 6. Furthermore, a cooling element 15 is arranged in the slide 6.

What is claimed is:

1. A method of creating a line made of plastic with a branch, the line and the branch respectively having interconnected flow cross sections and a common wall, comprising:
filling a mold corresponding to the line with the branch with liquid plastic; and
blowing out the flow cross section of the line, wherein
the flow cross section of the branch is pre-formed apart from an annular web adjacent to the flow cross section of the line and the web is subsequently severed.

2. The method as claimed in claim 1, wherein plastic located in the flow cross section of the branch is pulled out and the web is thereby severed.

3. The method as claimed in claim 1, wherein after the blowing out of the line, the flow cross section of the line is closed and the internal pressure in the line is increased until the plastic located in the flow cross section of the branch is forced out and the web is thereby severed.

4. The method as claimed in claim 1, wherein the removal of the plastic from the flow cross section of the branch takes place after it has at least partly solidified.

5. A mold for creating a line made of plastic with a branch, comprising:
a mold part corresponding to an outer wall of the line and of the branch;
means for creating an internal pressure for blowing out of a flow cross section of the line; and
a ring element arranged in a region of the flow cross section of the branch to reduce wall thickness during the blowing out of the flow cross section of the line.

6. The mold as claimed in claim 5, wherein the ring element is arranged on a slide protruding into the mold part and guided in a longitudinally movable manner.

7. The mold as claimed in claim 5, wherein the ring element has a peripheral cutting edge.

8. The mold as claimed in claim 5, wherein the ring element has points arranged in a circular form.

9. The mold as claimed in claim 5, wherein the ring element has in its center a cup-shaped or hemispherical depression or an undercut.

10. The mold as claimed in claim 6, further comprising a cooling element or a heating element arranged in the slide.
